(19) United States
(12) Patent Application Publication
(10) Pub. No.: US 2007/0181582 A1
(43) Pub. Date: Aug. 9, 2007

(54) System for fastening two components, method of fastening by means of this fastening system, and fuel system

(75) Inventors: Yannick Gerard, Kraainem (BE); Paul Plissart, Tervuren (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: Inergy Automotive Systems, Brussels (BE)

(21) Appl. No.: 10/591,293

(22) PCT Filed: Mar. 3, 2005
(86) PCT No.: PCT/EP05/50951

§ 371 Date: Mar. 23, 2007

(30) Foreign Application Priority Data
Mar. 4, 2004 (FR) 0402375

(51) Int. Cl. B62D 33/00

(52) U.S. Cl. 220/562

(57) ABSTRACT

A system for fastening, by welding, a component having a portion with a conical surface profile to a motor vehicle fuel tank that includes an opening whose perimeter has a conical surface profile. The welding is carried out between at least one portion of the conical surface of the perimeter of the opening in the tank and at least one portion of the conical surface of the component.

The subject of the present invention is a system for fastening two components, an associated fastening method and a fuel system.

Liquid and gas tanks used in industry or on board vehicles of various kinds must in general meet sealing and permeability standards with respect to the type of use for which they are designed and also the environmental requirements that they must comply with. At the present time, both in Europe and worldwide, the requirements regarding the limitation of polluting emissions in the atmosphere and in the environment in general are currently becoming considerably more strict (for example, the PZEV (“Partial Zero Emission Vehicle” standards in California). In addition, the permitted emission limits have become so low that losses due to leaks and to permeability of the interfaces between accessories and the tank have assumed a relatively higher proportion in the total losses of the tank/accessories system.

Moreover, it is becoming increasingly common to use tanks with a multilayer structure that includes one or more layers made of an impermeable material. The incorporation of accessories into such tanks poses the problem of how to fasten components to an opening made in these tanks in a sealed and impermeable manner.

The same applies to the fastening together of two components having a multilayer structure.

To solve the permeability problem, various techniques have already been devised for fastening a component to a tank, namely the addition of a welded film or hot wire welding (which are expensive solutions), the formation of a wide weld edge (a not very effective solution) or else treatment of the welded element, for example by sulphonation (again not a very effective solution). However, none of these techniques deals with the additional question of the strength of the fastening as such.

Moreover, it is known from U.S. Pat. No. 6,305,568 to weld a component to the periphery of an opening in a tank in such a way that the barrier layer present at the surface of the component is in contact with the barrier layer within the multilayer structure of the tank wall. The strength of the fastening is not optimal as the tank wall can deform under the load when fastening the component. Furthermore, the shape of the component, and especially its thickness at the point of the weld, must be adapted in order to give the weld sufficient mechanical strength. In particular in the case of a tubular component, this means the formation of a local overthickness, which uses up material and takes time (an additional manufacturing step) and therefore sometimes incurs a not-insignificant additional cost.

The object of the present invention is to provide a system for fastening two components, which considerably limits the losses of liquid and gas compared with conventional fastening systems, but which have above all increased strength and greater stability by the very design of the profile of the components in the fastening region. The object of the invention is also to provide a fastening system for fastening a part of generally tubular shape to a tank without having to make use of an overthickness or a complicated geometry, which is difficult to mould.

For this purpose, the invention relates to a system for fastening two components, each having a portion with a conical surface profile, such that the first component is fastened to the second component in such a way that the conical surfaces of the two components are, at least partly, in contact with each other. In particular, the invention relates to a system for fastening, by means of welding, a component having a portion with a conical surface profile to a motor vehicle fuel tank comprising an opening, the perimeter of which has a conical surface profile, the welding being carried out between at least one portion of the conical surface of the perimeter of the opening in the tank and at least one portion of the conical surface of the component.

According to the invention, two components (in fact a tank and a component to be fastened to the tank) are considered to be based on any material but preferably based on a plastic. Even more preferably, the fastening system is designed for components at least one of which comprises two different plastics. The expression “different plastics” is understood to mean materials that do not constitute a single material by physical blending of these plastics. In the particular case in which the components comprise two different plastics, the components are referred to as two-material components.

The term “plastic” is understood to mean any synthetic polymeric material, whether thermoplastic or thermosetting, which is in the solid state under ambient conditions, as well as blends of at least two of these materials. The intended polymers comprise both homopolymers and copolymers (especially binary or ternary copolymers). Examples of such copolymers are, non-limitingly: random copolymers, linear block copolymers, other block copolymers, and grafted copolymers. Thermoplastic polymers, including thermoplastic elastomers, and blends thereof, are preferred.

Any type of thermoplastic polymer or copolymer, the melting point of which is below the decomposition temperature, is suitable. Thermoplastics, which have a melting range spread over at least 10 degrees Celsius, are particularly suitable. Examples of such materials include those that exhibit polydispersion in their molecular weight.

In particular, the components according to the invention may be made of polyolefins, grafted polyolefins, thermoplastic polyesters, polyketones, polyamides and copolymers thereof.

A polymer often present in the components according to the invention is polyethylene. Excellent results have been obtained with high-density polyethylene (HDPE).

The plastic components according to the invention are preferably in the form of components with a multilayer structure. Particularly preferred components are those whose structure includes at least one layer made of a barrier material, that is to say a material, generally of polymeric nature, which possesses a very high impermeability to certain liquids and gases.

According to one particular embodiment, it is possible to incorporate a barrier material into one of the layers of the component or to insert one particular additional layer, essentially consisting of a barrier material, into the structure. It is preferred to insert an additional layer essentially consisting of a barrier material into the structure.

According to one particular embodiment, use may for example be made of known barrier compositions such as those used to make fuel tanks impermeable. Examples of such barrier materials are, non-limitingly: resins based on polyamides or copolyamides, random ethylene/vinyl alcohol copolymers (EVOH) or else thermotropic liquid-crystal polymers such as copolymers of p-hydroxybenzoic acid and of either 6-hydroxy-2-naphthoic acid or of terephthalic acid and 4,4′-biphenol (for example the copolyesters sold under the brand name XYDAR®).

According to another particular embodiment, the multilayer structure of the first component may be different from that of the second component. It may also be identical to that of the second component. Fastening systems in which the structure of the first component is identical to that of the second component are often preferred. Most particularly preferred are systems in which, within identical structures, the barrier materials are themselves identical and constitute identical polymeric layers.

Components formed from the same multilayer structure, comprising at least two high-density polyethylene (HDPE) layers between which an EVOH layer is inserted, are particularly preferred.

The two components in question in the invention each have a conical surface profile. Within the context of the invention, the term “conical surface” is understood to mean a surface generated by a moveable curve that passes through a fixed point running along a directrix. The conical surface may or may not be a surface of revolution, depending on whether or not the directrix is a circle. Advantageously, but not exhaustively, it is possible to consider conical (axisymmetric) surfaces, pyramidal surfaces, spherical surfaces, elipsoidal surfaces or any other surface meeting the above definition. The conical surface is generally obtained during the manufacture of the component, for example by deforming the wall of the component so as to generate an angle in the wall. The conical surface is then formed by the surface of the deformed portion of the wall of the component. The expression “the angle of the conical surface thus obtained” is understood to mean the angle between the tangent to the moveable curve at the fixed point and the axis of the conical surface passing through this point. Advantageously, this angle has a value of between 1 and 90 degrees. Preferably, this angle has a value of between 30 and 60 degrees. Even more preferably, a value of between 40 and 50 degrees is chosen. A value of 45 degrees is particularly preferred. The value of the angle of the conical surface for the other component is defined in such a way that the two conical surfaces are at least partly in contact with each other.

In the particular case in which the wall of the components has undergone several deformation operations, the conical surface is that defined by the last deformation.

The moveable curve that defines the conical surface may advantageously be a straight line, a circular arc, or any other curve, in particular it may be formed from a number of curve segments connected together. The angle of the conical surface will, in the latter case, be defined relative to the first curve segment of the conical surface.

The term “conical surface” is not meant to denote oblique cut-outs in the wall of the component.

Advantageously, the deformation operation may be carried out on the wall by any wall-forming technique or by producing the conical surface during manufacture of the component, the latter variant being preferred. Such a type of profile gives the fastening system greater strength, in particular when the components are subjected to a load (for example when fastening them). This is because, when a component is fastened to the wall of a tank if said wall does not have relief in the weld zone, the load exerted on the wall by the component during fastening results in a deformation of the wall, directed towards the inside of the tank. The quality of the fastening is in this case limited and the length of contact between the accessory and the tank wall is reduced. On the other hand, when the tank wall has a profile of conical shape, it deforms less under an external load and the contact between the accessory and the wall covers a larger area than in the previous case.

If the conical surface is defined by a circular arc, it corresponds to a spherical surface. This surface shape has the advantage of getting round the problem of the components rotating when they are fastened to each other: the spherical surface allows good fastening, independently of any misalignment (possibly due to the flexibility of the components during fastening).

According to the invention, the conical surfaces of the two components are at least partly welded to each other. By this is meant that the components are fastened by the contacting and partial interpenetration of the molecules of a portion of the surface of one end of the first component, forming a joint surface, with the molecules of a similar surface of the second component.

Advantageously, the components are fastened by raising the temperature in the weld zones, for example by preheating these zones. The technique of hot-plate welding, also called mirror welding, is particularly preferred.

According to the invention, the materials of the two contacting conical surfaces are therefore made of weldable materials. Advantageously, these are the same material, or materials that are compatible (intrinsically, or made compatible by a suitable chemical treatment, such as for example by grafting).

The term “weldable” is understood here to mean chemical and physical compatibility of the constituents of the respective compositions of the layer of the first component with the layer of the second component to which it is welded. Good compatibility avoids the phenomenon of segregation of certain constituents of the respective compositions of the welded portions. In general, good compatibility guarantees long-term adhesion between the two components.

In the particular case in which the two components have a multilayer structure, at the point where the two components are fastened together the multilayer structures of the components are superposed in such a way that the number of superposed layers is equal to the sum of the number of layers in the first component and the number of layers in the second component. This arrangement of the layers reduces the risks of a liquid and/or gas leak and improves the level of impermeability in the fastening region, in particular when the fastening is carried out by welding.

According to the invention, the second component is a tank that has an opening whose perimeter has a conical surface profile used for fastening the first component by welding.

The term “opening” is understood within the context of the present invention to mean in fact a discontinuity in the wall of the tank that brings the internal volume of the latter into communication with the outside. This discontinuity may be in the same surface as the wall of the tank or it may be reentrant (directed towards the internal volume of the tank) or salient (directed towards the outside). In the first case, the opening is generally referred to as a hole. In the second case, this is referred to instead as an excrescence. According to the invention, the hole or the excrescence has at least party a conical surface. Conical excrescences of reentrant shape are preferred.

The term “fuel tank” is understood within the context of the invention to mean any type of tank capable of storing a liquid and/or gaseous fuel under varied temperature and pressure conditions. More particularly intended are tanks of the type of those encountered in motor vehicles. The expression “motor vehicle” is understood to also include cars, motorcycles and lorries.

Certain tanks have one or more openings as described above, for example so as to fasten one or other of the accessories taken from the following non-exhaustive list: a plate, a delivery tube, a fitting, a spout, a valve or any other accessory of the fuel tank.

Another preferred embodiment of the invention is that in which the component to be fastened to the opening in the tank has a generally tubular shape.

The invention also relates to a fuel system comprising a fuel tank and at least one accessory fastened to the fuel tank by means of the fastening system described according to the invention.

The invention also relates to a method of fastening two components together (one being a fuel tank and the other a component/accessory for the said tank) using the fastening system as described above.

Finally, the invention relates to a method of manufacturing a fuel system in which:
1. a tank comprising an opening, the perimeter of which has a conical surface profile, is manufactured;
2. a component having a part with a conical surface profile is manufactured; and
3. at least one portion of the conical surface of the perimeter of the opening in the tank is welded to at least one portion of the conical surface of the component.

As mentioned above, it is advantageous to form the conical surface of the tank and of the component during their actual manufacture. It is most particularly preferred for the manufacture of these two components to take place by moulding using one or more moulds having impressions corresponding to the conical surfaces. This makes it possible, compared with the use of “flat” moulds, to avoid an additional step of forming the conical surface by deforming the already moulded wall of the tank and/or of the component.

Again, as already mentioned, the welding technique used within the context of the invention is preferably hot-plate welding. Using self-centring hot plates, or a robotic system optionally controlled by a camera, gives good results within the context of this variant of the invention. This is because, when fastening the component to the tank, the most critical parameter is the centring of the hot plate with respect to the cone constituting the welding surface.

The figures that follow have the purpose of illustrating the invention without seeking to restrict its scope.

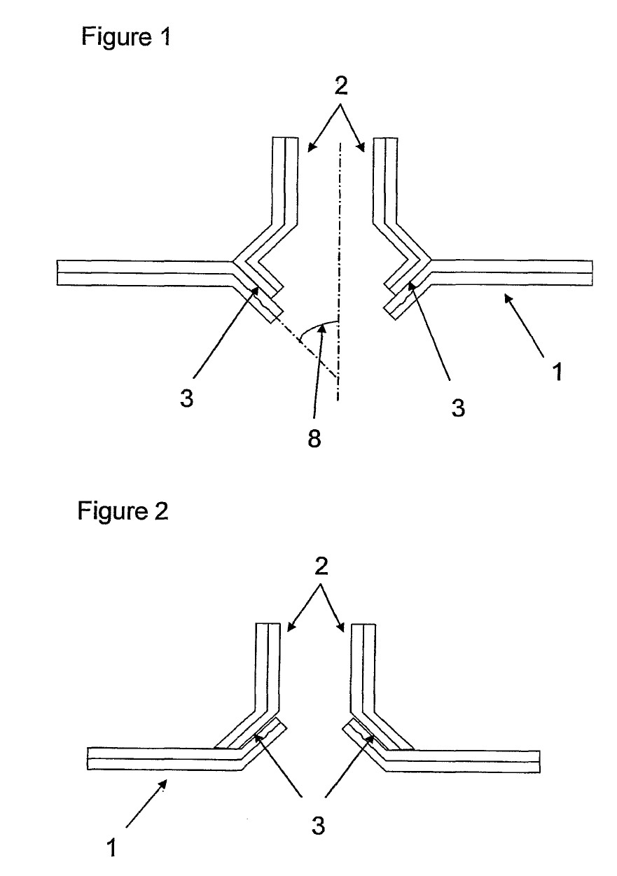

FIG. 1 illustrates a first embodiment of the invention: the multilayer wall (1) of the tank has an opening whose outline has a conical shape oriented towards the inside of the tank. The angle (8) is the angle of the conical surface. The multilayer nozzle (2) has an end whose profile is matched to that of the opening in the reservoir in such a way that the outer layer of the nozzle is welded to the outer layer of the tank at the point of the opening along a weld zone (3).

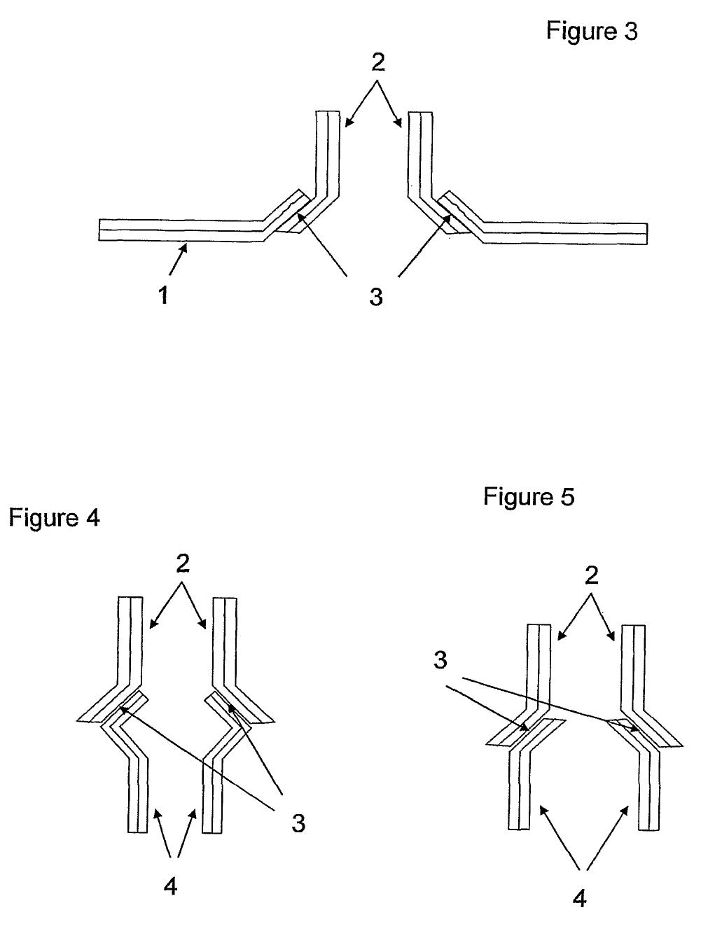

FIGS. 2 and 3 illustrate two additional embodiments in which the nozzle (2) is welded in such a way that either the inner layer of the nozzle (2) is welded to the outer layer of the wall (1) of the tank (FIG. 2), or the outer layer of the nozzle (2) is welded to the inner layer of the wall (1).

FIGS. 4 and 5 illustrate the welding of two nozzles, one of them being in fact formed by a tubular excrescence of a fuel tank (not shown in these figures). In both cases, there is superposition in the weld zone of the inner layer of the nozzle (2) and the outer layer of the nozzle (4).

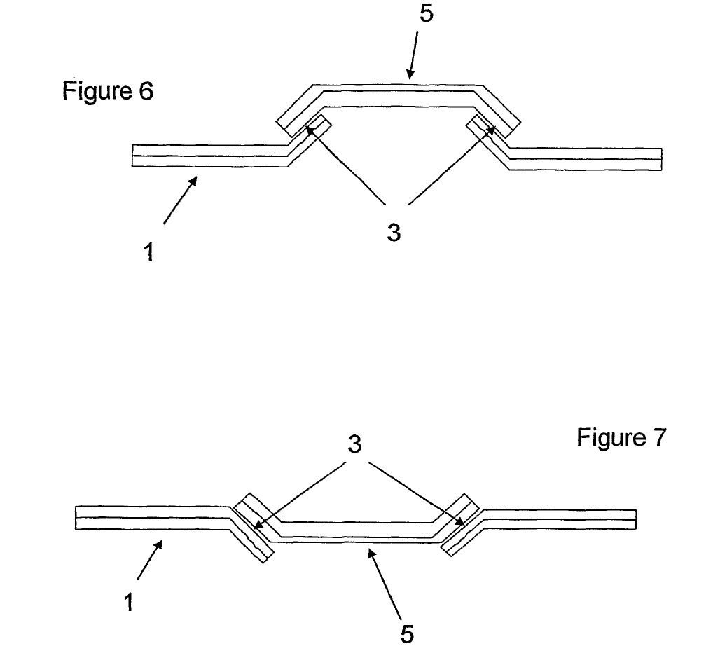

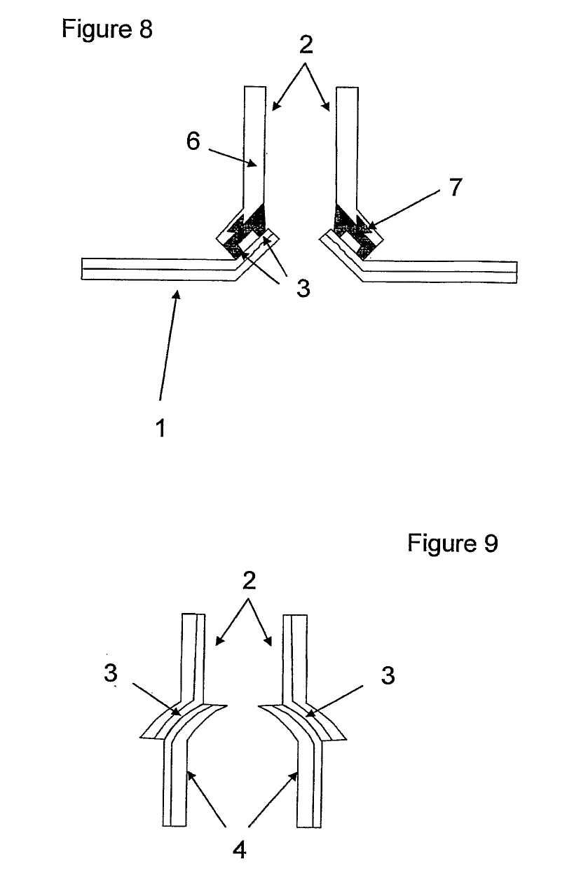

FIGS. 6 and 7 correspond to the case in which a plate (5) is welded to the wall (1) of a tank.

FIG. 8 illustrates the case in which a two-material component (2) is 10 fastened to the multilayer wall (1) of a tank.

FIG. 9 presents the case of components (2) and (4) whose contacting conical surfaces are defined by a curve that is not a straight line but a circular arc, one of the components in fact being formed by a tubular excrescence of a fuel tank (not shown in this figure).

1-10. (canceled)

11. A system for fastening, by welding, a component having a portion with a conical surface profile to a motor vehicle fuel tank comprising an opening, a perimeter of which has a conical surface profile, the welding being carried out between at least one portion of the conical surface of the perimeter of the opening in the tank and at least one portion of the conical surface of the component.

12. The fastening system according to claim 11, wherein the tank and the component are based on one or more plastics.

13. The fastening system according to claim 12, wherein at least one of the two components has a multilayer structure that includes a layer made of a barrier material.

14. The fastening system according to claim 13, wherein the two components are formed from a multilayer structure and, at a point where the first component is fastened to the second component, a number of superposed layers is at most equal to a sum of a number of layers in the first component and a number of layers in the second component.

15. The fastening system according to claim 14, wherein the multilayer structure includes at least two layers of high-density polyethylene (HDPE) between which a layer made of an ethylene/vinyl alcohol copolymer (EVOH) is inserted.

16. The fastening system according to claim 11, wherein the component is chosen from a plate, a delivery tube, a fitting, a spout, a valve, or any other accessory of the fuel tank.

17. A fuel system comprising a fuel tank and at least one accessory fastened to the fuel tank by the fastening system according to claim 11.

18. A method of manufacturing a fuel system, comprising:
manufacturing a tank comprising an opening, a perimeter of which has a conical surface profile;
manufacturing a component having a part with a conical surface profile; and
welding at least one portion of the conical surface of the perimeter of the opening in the tank to at least one portion of the conical surface of the component.

19. The method according to claim 18, wherein the tank and the component are manufactured by molding by using one or more molds having impressions corresponding to the conical surfaces.

20. The method according to claim 18, wherein the welding is hot-plate welding using self-centring hot plates or a robotic system optionally controlled by a camera.
